(19) United States
(12) Patent Application Publication
(10) Pub. No.: US 2002/0168906 A1
(43) Pub. Date: Nov. 14, 2002

(54) Net-like planar polymer assembly

(75) Inventors: Christian Schlossnikl, Vocklabruck (AT); Heinrich Firgo, Vocklabruck (AT)

Correspondence Address: BAKER BOTTS L.L.P., 44TH FLOOR, 30 ROCKEFELLER PLAZA, NEW YORK, NY, 10112-0228, US

(73) Assignee: LENZING AKTIENGESELLSCHAFT

(21) Appl. No.: 10/185,362

(22) Filed: Jun. 27, 2002

Related U.S. Application Data
(63) Continuation of application No. 09/193,028, filed on Nov. 16, 1998.
Application No. 09/193,028 is a continuation of application No. PCT/AT98/00073, filed on Mar. 20, 1998.

(30) Foreign Application Priority Data
Mar. 21, 1997 (AT) A 496/97

(51) Int. Cl. B32B 27/04; B32B 27/12; D04B 1/00; D04G 1/00; D03D 9/00; D04B 21/00; B29C 67/00

(52) U.S. Cl. 442/1; 442/38; 264/137; 28/140

(57) ABSTRACT

The invention relates to a planar assembly made of a polymer, which planar assembly includes threads interconnected in a net-like manner via connection sites while forming meshes, wherein the threads at least partially are fused together on the connection sites, and is characterized in that the polymer substantially is cellulose.

The present invention relates to a planar assembly made of a polymer, which planar assembly includes threads interconnected in a net-like manner via connection sites while forming meshes, wherein the threads at least partially are fused together on the connection sites. The present invention, furthermore, relates to a process for producing such a planar assembly.

It is known that thermoplastics can be processed to webs of net- or fabric-like structures (General Survey in “Kunststoffe”, Vol. 52, pp. 492-494, 1962 and “KunststoffExtrudertechnik”, 2nd Edition, pp. 446-450, 1963, Carl Hanser Verlag Munich). Multihole systems in circular or flat arrangements are used as extrusion tools or extrusion dies, each die hole being composed of two half-holes located in two distinct structural elements which are relatively moved in close contact. That tool may be regarded as a mixture of a multihole head and a film-blowing extrusion head of zero gap width and a rotating annular mouth piece and optionally also a counter-rotating mandrel. Movement may be in the form of a continuous rotation or a periodically alternating rotation. Such a movement causes the rows of holes to be regularly brought to coincidence and separated again. The “nods” of the net, i.e., the connection sites are formed during coincidence and the meshes are formed in the other phase.

The synthetic nets obtained subsequently may be stretched in the longitudinal direction and/or in the transverse direction in order to impart the desired mechanical properties to the net. Processes of this type are described, for instance, in GB-A-91 11 304, GB-A-89 20 843, GB-A-85 09 498, GB-A-82 19 477 and GB-A-81 10 472.

The extruded synthetic nets are used for a plurality of applications such as, e.g., packages for food, protective nets for sensitive surfaces, reinforcements for geotextiles, etc.

Thermoplastic polymers such as, e.g., polyethylene and polypropylene are used as synthetics for the production of such nets. They can form nods by the polymer threads fusing or welding together. Such polymers are, however, not biologically degradable such that the above-mentioned products must be disposed of.

It is the object of the present invention to provide net-like planar assemblies of a biologically degradable polymer.

The net-like planar assembly according to the invention comprises threads interconnected in a net-like manner via connection sites while forming meshes, wherein the threads at least partially are fused together on the connection sites, and is characterized in that the polymer substantially is cellulose.

The planar assembly according to the invention may be produced by molding a moldable or spinnable mass containing the polymer by means of an extrusion die comprising two groups of spinning orifices capable of being moved relative to each other and arranged so as to enable the formation of meshes, wherein a solution of cellulose in an aqueous tertiary amine oxide is used as the moldable mass, which solution is conducted into an aqueous precipitation bath via an air gap after having left the extrusion die.

The invention is, thus, based on the surprising finding that spinnable solutions of cellulose in an aqueous tertiary amine oxide may be molded to net-like assemblies according to the same process and by means of the same tools as they are used for the production of nets of thermoplastics, which net-like assembly may be drawn via an air gap into a precipitation bath in which the cellulose is precipitated and the net is fixed.

The nod and mesh structure of the molded solution is stable to such a high degree that the cellulose solution molded to a net by means of the extrusion die may even be stretched in the air gap, stretching being feasible both in the extrusion direction and transverse thereto without tearing of the molded cellulose solution.

In the process according to the invention N-methylmorpholine-N-oxide is preferably used as a tertiary amine oxide.

The invention, furthermore, relates to the use of a spinning device known per se for producing synthetic nets, for the production of net-like planar assemblies of cellulose.

A process for producing spinnable or moldable solutions of cellulose in an aqueous tertiary amine oxide is known, for instance, from EP-A-0 356 419. According to that publication, a suspension of cellulose in an aqueous tertiary amine oxide is initially prepared. The amine oxide contains water by up to 40% by mass. The aqueous cellulose suspension is heated and water is drawn off under decreasing pressure until the cellulose is dissolved.

For the production of cellulose fibers it is known from DE-A-28 44 163 to provide an air path or air gap between spinneret and precipitation bath in order to obtain a spinneret draft. That spinneret draft is necessary, since stretching of the threads is rendered very difficult after a contact of the formed spinning solution with the aqueous precipitation bath. The fiber structure adjusted in the air gap is fixed in the precipitation bath.

A device and a process for producing seamless tubular films is known from WO 93/13670. According to that known process, the cellulose solution is molded to a tube by an extrusion die having an annular extrusion gap, which tube is drawn over a cylindrical mandrel and introduced into a precipitation bath.

From WO 95/35340 a blowing process for producing oriented cellulose films by spinning a cellulose solution in a precipitation bath is known, in which the solution is extruded through a film blowing die and an external air gap downwardly into the precipitation bath.

From DE-A-195 15 137 a process for producing tubular films is known, according to which a cellulose solution at first is extruded to a tube, which tube on its way from the annular die outlet to the entry into the precipitation medium is stretched in the direction of extrusion and widened, i.e., extended at a ratio ranging between 1:1 and 1:10 by a gas pressure acting in the tube interior. By that extension, the tube is thus stretched transverse to the direction of extrusion.

A device for the production of cellulosic tubular films by extruding a solution of cellulose in a tertiary amine oxide into a precipitant present below the device, which device comprises an extrusion die having a substantially annular extrusion gap, wherein a feed duct for precipitant and a discharge duct for used precipitant are provided in the interior of the ring formed by the extrusion gap, may also be taken from WO 95/07811. In that device, a spacer disc may be provided below the discharge duct in order to prevent the extruded tubular film from collapsing in the precipitation bath.

A preferred configuration of the planar assembly according to the invention is characterized in that a portion of the meshes is filled up. It is also possible that all of the meshes are filled up. In that case, the planar assembly according to the invention is a film having a net-like reinforcement.

A further configuration of the planar assembly according to the invention is characterized in that it comprises film-like sections.

The planar assembly obtained after cellulose precipitation preferably is washed, wherein various auxiliary substances such as, e.g., glycerine, may be introduced during or also after the washing procedure. After this, the planar assembly is dried and/or further confectionated. It has proved beneficial to introduce the auxiliary substances already prior to final drying, since the absorbability is substantially higher in that state. With some auxiliary substances such as, e.g., certain colors and plasticizers it may also be advantageous to introduce the auxiliary substances into the spinning mass already prior to molding.

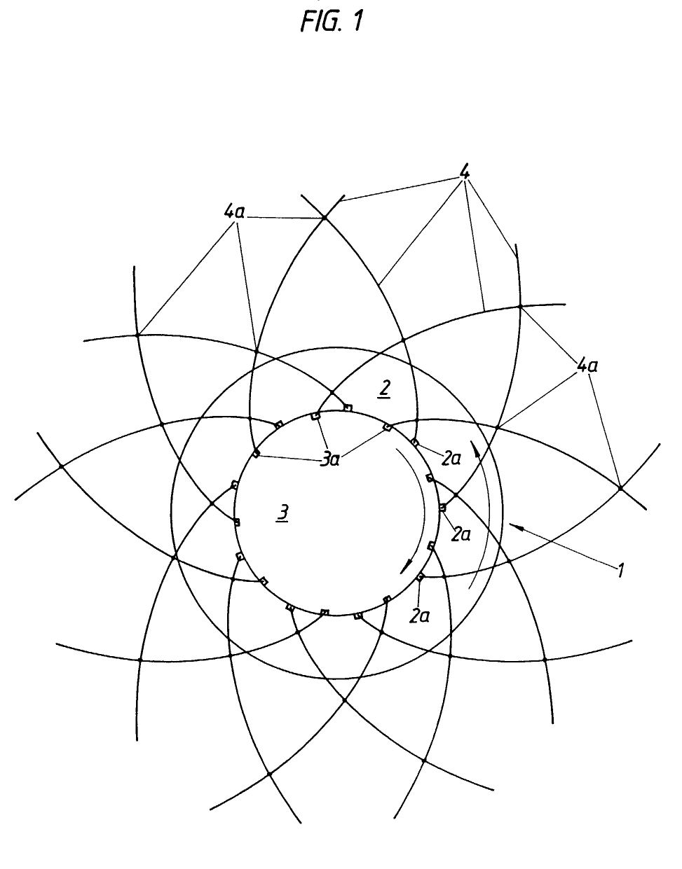

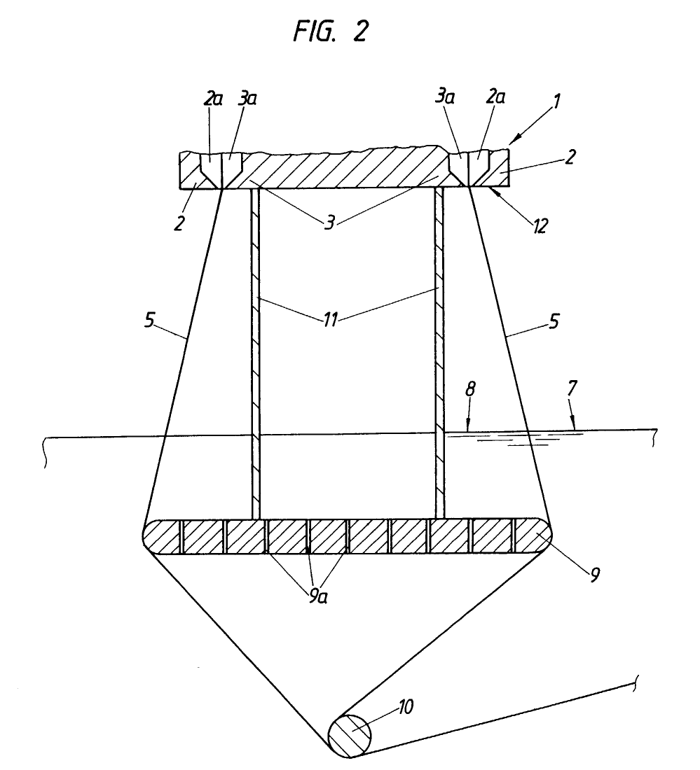

Preferred embodiments of the invention will be explained in more detail by way of the annexed drawing comprising FIGS. 1 and 2.

FIG. 1 depicts the lower side of a spinneret used in the prior art for producing nets of thermoplastic polymers. That technique is described, for instance, in “Extrusions-Werkzeuge für Kunststoffe und Kautschuk”, 2nd Ed., pp. 207-208, Carl Hanser Verlag Munich-Vienna, and in “Kunststoff-Extrudertechnik”, G. Schenkel, 2nd Ed., pp. 446-449, Carl Hanser Verlag Munich, 1963. Spinnerets for the production of such nets are offered, for instance, by Netlon Limited, Blackburn, England.

In FIG. 1, reference numeral 1 denotes the spinneret, or extrusion tool, which comprises two circular rows 2a, 3a of spinning orifices or dies. One row of dies 2a is arranged on the internal edge of a circular disc 2 and the other row of dies 3a is arranged on the external edge of a concentric circular disc 3. By extruding a spinnable cellulose solution, a net-like tube will be formed if the two die rings 2, 3 rotate or oscillate in opposite senses. The rotation or oscillation of the die rings 2, 3 is indicated by arrows. The connection sites of the net are formed as two dies are each facing each other and the emerging threads are contacting each other. In doing so, these threads fuse or glue together.

The threads emerging from the spinneret 1 are denoted by reference numeral 4. In the illustration depicted in FIG. 1, the threads 4 move toward the viewer, the viewer looking into the net-like tube forming. The connection sites on which the threads 4 have glued or fused together, i.e. the “nods” of the net, are denoted by reference numerals 4a. The areas between the threads 4 are the “meshes” of the net.

After extrusion, the cellulose solution molded in a net-like manner in the air gap is conducted into an aqueous precipitation bath for precipitating the cellulose and fixing the net structure. A device of this type is schematically illustrated in section in FIG. 2.

FIG. 2 by 1 shows the spinneret depicted in FIG. 1, in a position in which the dies of die row 2a are facing the dies of die row 3a. The cellulose solution is extruded through the moving rows of dies 2a, 3a, thereby extruding the cellulose solution in the form of a net 5 into the air space present between the surface 7 of the precipitation bath and the lower side 12 of the die 1.

The solution 5 extruded as a net-like tube is drawn off into the precipitation bath 7, where it gets into contact with a precipitant, thus causing the dissolved cellulose to coagulate and the amine oxide to be released into the precipitation bath.

The net-like tube 5 is drawn off via the deflection means 10 and thereby stretched in the transport direction, i.e., in the direction toward the precipitation bath 7.

The net-like tube 5 is drawn over a spacer 9. This spacer 9 has the form of a circular disc firmly connected with the die 1 by means of rods 11. The spacer 9 may comprise continuous bores 9a for mass transfer. Instead of a disc, a ring may be provided as the spacer.

The net-like tube 5 is extended by the spacer 9, this corresponding to stretching transverse to the transport direction. It is evident that such stretching transverse to the extrusion direction increases with the size of the circular spacer 9.

The spacer preferably is designed such that the size of the cross sectional area may be changed. This is feasible, for instance, with a disc, or a ring, including displaceable members in a manner analogous to an apertured diaphragm, in which the displaceable parts may slide on one another, thereby enabling the external diameter to be changed.

Furthermore, a change in the size of the cross sectional area may be reached in that the spacer is comprised of an elastic ring, for instance of rubber, to which air, water or the like may be fed. The diameter of the elastic ring is, thus, controllable via the medium contained in its interior. A variant of this embodiment consists in that no complete ring is used, but the inner side is comprised of a solid part of, e.g., steel or plastics and an elastic part is attached to the same. Another embodiment consists in a semi-shell, optionally comprised of segments, whose fixed point is displaceable, thereby changing the external diameter (umbrella principle).

If, in the die 1 illustrated in FIG. 1, a sliding gap of, e.g., some tenths of a millimeter is adjusted, the cellulose solution can be molded to a film having net-like reinforcements or to a net having filled-up meshes. Also this planar assembly can be produced by a device as illustrated in FIG. 2 provided a gap for extruding the film portion between the meshes is provided between die rows 2a and 3a. Furthermore, a supply duct and a discharge duct must be provided in order to get precipitant 8 into the interior of the tube and again out of it. Such supply and discharge ducts are known for instance from WO 95/07811 to Applicant in a spinning device for producing cellulosic films.

Stretching transverse to the extrusion direction may be obtained by means of a spacer disc 9. When using a blown film device known per se, transverse stretching may be obtained also by means of a gas pressure in the interior of the film tube 5. The blowing die principle is known, for instance, from EP-A -0 662 283.

It has been shown that a spinnable cellulose solution may be processed not only to tubular nets, but also to flat nets. To this end, various embodiments are feasible. Thus, the process described above in respect of an annular die may be realized also with a flat die. In that case, the two die halves will perform an oscillating movement relative to each other by moving either one or both of the die halves, thereby causing a relative movement of the two die halves.

Another possibility consists in that the dies are formed by slotted die discs immediately consecutely arranged and performing relatively oscillating movements, wherein at least the slot of one die disc has the form of a line with multiple directional changes and wherein the slot lines of both die discs extend in a manner so as to brush over each other along their total extension during their relative movement, thereby constantly overlying each other in a number of points. Such die arrangements are described, for instance, in “Kunststoffe”, Vol. 52, No. 8, pp. 492-494, 1962 and allow for the production of planar assemblies according to the invention in which a portion of the meshes are filled up. It is, furthermore, possible to produce planar assemblies having film-like sections.

It has, furthermore, proved suitable to dry the planar assembly according to the invention after washing while preventing shrinking at the same time. Cylinder drying, hot-air drying, drying by means of infrared radiation and microwaves and suction cylinder drying are particularly suitable drying procedures. When applying cylinder drying, the planar assembly may be prevented from shrinking, for instance, in a simple manner by laid-on strips following on.

What we claim is:

1. A planar assembly made of a polymer and including threads interconnected in a netlike manner via connection sites so as to form meshes, said threads at least partially being fused together on said connection sites, wherein said polymer substantially is cellulose.

2. A planar assembly as set forth in claim 1, wherein a portion of said meshes is filled up.

3. A planar assembly as set forth in claim 1, wherein all of said meshes are filled up.

4. A planar assembly as set forth in claim 1, wherein said planar assembly comprises film-like sections.

5. A process for producing a planar assembly of a polymer-containing moldable mass, which planar assembly includes threads interconnected in a net-like manner via connection sites while forming meshes and fused together at least partially on said connection sites, which process comprises the steps of
providing an extrusion die including two groups of spinning orifices capable of being moved relative to each other and arranged to enable the formation of said meshes, providing an air gap below said extrusion die, and providing an aqueous precipitation bath below said air gap,
preparing a solution of cellulose in an aqueous tertiary amine oxide as said polymer-containing moldable mass,
molding said moldable mass by said extrusion die so as to obtain a molded cellulose solution leaving said extrusion die, and
conducting said molded cellulose solution into said aqueous precipitation bath via said air gap, thereby precipitating said cellulose and obtaining a net-like planar assembly.

6. A process as set forth in claim 5, further comprising stretching in said air gap said molded cellulose solution molded by said extrusion die, stretching being feasible in at least one of the direction of extrusion and a direction transverse thereto.

7. A process as set forth in claim 5, wherein said net-like planar assembly formed by precipitating said cellulose is transported through said precipitation bath and subsequently dried while keeping said net-like planar assembly under tension in order to prevent shrinking.

8. A process as set forth in claim 5, wherein N-methylmorpholine-N-oxide is used as said tertiary amine oxide.

9. A planar assembly comprising a polymer, the assembly including threads interconnected in a net structure at connection sites thereby forming a mesh, said threads being at least partially fused together at said connection sites, wherein said polymer comprises cellulose.

10. A planar assembly according to claim 9 wherein the mesh includes interstitial spaces and wherein a portion of said interstitial spaces are filled.

11. A planar assembly according to claim 9 wherein the mesh includes interstitial spaces and wherein all the interstitial spaces are filled.

12. A planar assembly according to claim 9 wherein said planar assembly comprises portions which are in the form of a film.

13. A process for producing a planar assembly of a polymer-containing moldable mass wherein said planar assembly comprises a polymer and includes threads interconnected in a net structure at connection sites thereby forming a mesh, said threads being at least partially fused together at said connection sites, said process comprising the steps of:
providing an extrusion die including two groups of spinning orifices capable of being moved relative to each other and arranged to enable formation of said mesh;
providing an air gap located below said extrusion die;
providing an aqueous precipitation bath located below said air gap;
preparing a solution of cellulose in an aqueous tertiary amine oxide wherein said solution is a polymer containing moldable mass;
molding said moldable mass by conveying said moldable mass through said extrusion die thereby forming a molded cellulose solution; and
conveying said molded cellulose solution through said air gap and into said aqueous precipitation bath, thereby precipitating said cellulose to form a planar assembly of cellulose arranged as a net structure.

14. A process according to claim 13 further comprising stretching said molded cellulose solution molded by said extrusion die in said air gap wherein said molded cellulose solution is stretched in at least one of the direction of extrusion and a direction transverse thereto.

15. A process according to claim 13 comprising transporting said precipitated cellulose through said precipitation bath and subsequently drying said precipitated cellulose.

16. A process according to claim 13 comprising transporting said precipitated cellulose through said precipitation bath and subsequently drying said precipitated cellulose while maintaining said precipitated cellulose under tension to prevent shrinking.

17. A process according to claim 13 wherein said tertiary amine oxide comprises N-methlymorpholine-N-oxide.
